(19) United States
(12) Patent Application Publication
(10) Pub. No.: US 2016/0378863 A1
(43) Pub. Date: Dec. 29, 2016

(54) SELECTING REPRESENTATIVE VIDEO FRAMES FOR VIDEOS

(71) Applicant: Google Inc., Mountain View, CA (US)

(72) Inventors: Jonathon Shlens, San Francisco, CA (US); George Dan Toderici, Mountain View, CA (US); Sami Ahmad Abu-El-Haija, San Francisco, CA (US)

(21) Appl. No.: 14/749,436

(22) Filed: Jun. 24, 2015

(51) Int. Cl. G06F 17/30; G06N 3/08

(52) U.S. Cl. CPC G06F 17/30843; G06N 3/08

(57) ABSTRACT

Methods, systems, and apparatus, including computer programs encoded on computer storage media, for selecting representative frames for videos. One of the methods includes receiving a search query; determining a query representation for the search query; obtaining data identifying a plurality of responsive videos for the search query, wherein each responsive video comprises a plurality of frames, wherein each frame has a respective frame representation; selecting, for each responsive video, a representative frame from the responsive video using the query representation and the frame representations for the frames in the responsive video; and generating a response to the search query, wherein the response to the search query includes a respective video search result for each of the responsive videos, and wherein the respective video search result for each of the responsive videos includes a presentation of the representative video frame from the responsive video.

### BACKGROUND

This specification relates to Internet video search engines.

Internet search engines aim to identify Internet resources and, in particular, videos, that are relevant to a user's information needs and to present information about the videos in a manner that is most useful to the user. Internet video search engines generally return a set of video search results, each identifying a respective video, in response to a user submitted query.

### SUMMARY

In general, one innovative aspect of the subject matter described in this specification can be embodied in methods that include the actions of receiving a search query, wherein the search query comprises one or more query terms; determining a query representation for the search query, wherein the query representation is a vector of numbers in a high-dimensional space; obtaining data identifying a plurality of responsive videos for the search query, wherein each responsive video comprises a plurality of frames, wherein each frame has a respective frame representation, and wherein each frame representation is a vector of numbers in the high-dimensional space; selecting, for each responsive video, a representative frame from the responsive video using the query representation and the frame representations for the frames in the responsive video; and generating a response to the search query, wherein the response to the search query includes a respective video search result for each of the responsive videos, and wherein the respective video search result for each of the responsive videos includes a presentation of the representative video frame from the responsive video.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Particular embodiments of the subject matter described in this specification can be implemented so as to realize one or more of the following advantages. By selecting representative frames from videos that have been classified as responsive to a received search query by a video search engine, the user experience of a user of the video search engine can be improved. In particular, because the representative video frames are selected in a manner that is dependent on the received search query, the relevance of a given responsive video can be effectively indicated to the user by including a presentation of the representative frame in a search result that identifies the responsive video. Additionally, by including a link in the search result that, when selected, initiates playback of the responsive video starting from the representative frame, the user can easily navigate to the most relevant portion of the responsive video.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example video search system.

FIG. 2 is a flow diagram of an example process for generating a response to a received search query.

FIG. 3 is a flow diagram of an example process for determining a frame representation for a video frame.

FIG. 4 is a flow diagram of an example process for determining a frame representation for a video frame using a modified image classification system.

FIG. 5 is a flow diagram of an example process for training a modified image classification system.

Like reference numbers and designations in the various drawings indicate like elements.

### DETAILED DESCRIPTION

This specification generally describes a video search system that generates responses to search queries that include video search results. In particular, in response to a search query, the system selects a representative video frame from each of a set of responsive videos and generates a response to the search query that includes video search results that each identify a respective responsive video and include a presentation of the representative video frame from the responsive video.

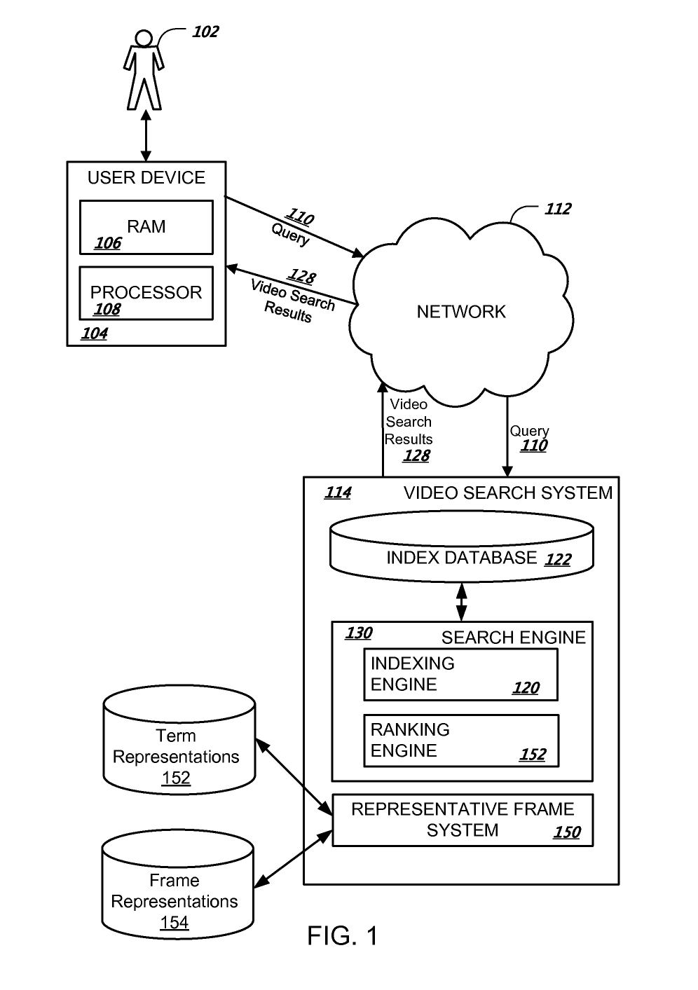

FIG. 1 shows an example video search system 114. The video search system 114 is an example of an information retrieval system implemented as computer programs on one or more computers in one or more locations, in which the systems, components, and techniques described below are implemented.

A user 102 can interact with the video search system 114 through a user device 104. The user device 104 will generally include a memory, e.g., a random access memory (RAM) 106, for storing instructions and data and a processor 108 for executing stored instructions. The memory can include both read only and writable memory. For example, the user device 104 can be a computer, e.g., a smartphone or other mobile device, coupled to the video search system 114 through a data communication network 112, e.g., local area network (LAN) or wide area network (WAN), e.g., the Internet, or a combination of networks, any of which may include wireless links.

In some implementations, the video search system 114 provides a user interface to the user device 104 through which the user 102 can interact with the video search system 114. For example, the video search system 114 can provide a user interface in the form of web pages that are rendered by a web browser running on the user device 104, in an app installed on the user device 104, e.g., on a mobile device, or otherwise.

A user 102 can use the user device 104 to submit a query 110 to the video search system 114. A video search engine 130 within the video search system 114 performs a search to identify responsive videos for the query 110, i.e., videos that the video search engine 130 has classified as matching the query 110.

When the user 102 submits a query 110, the query 110 may be transmitted through the network 112 to the video search system 124. The video search system 114 includes an index 122 that indexes videos and the video search engine 130. The video search system 114 responds to the search query 110 by generating video search results 128, which are transmitted through the network 112 to the user device 104 for presentation to the user 102, e.g., as a search results web page to be displayed by a web browser running on the user device 104.

When the query 110 is received by the video search engine 130, the video search engine 130 identifies responsive videos for the query 110 from the videos that are indexed in the index 122. The search engine 130 will generally include a ranking engine 152 or other software that generates scores for the videos that satisfy the query 110 and that ranks the videos according to their respective scores.

The video search system 114 includes or can communicate with a representative frame system 150. After the video search engine 130 has selected responsive videos for the query 110, the representative frame system 150 selects a representative video frame from each of the responsive videos. The video search system 114 then generates a response to the query 110 that includes video search results.

Each of the video search results identifies a respective one of the responsive videos and includes a presentation of the representative frame selected for the responsive video by the representative frame system 150. The presentation of the representative frame may be, e.g., a thumbnail of the representative frame or another image that includes content from the representative frame. Each video search result also generally includes a link that, when selected by a user, initiates playback of the video identified by the video search result. In some implementations, the link initiates playback starting from the representative frame from the responsive video, i.e., the representative frame is the starting point for playback of the video rather than the first frame in the video.

The representative frame system 150 selects the representative frame from a given responsive video using term representations stored in a term representation repository 152 and frame representations stored in a frame representation repository 154.

The term representation repository 152 stores data that associates each term of a pre-determined vocabulary of terms with a term representation for the term. The term representations are vectors of numeric values in a high-dimensional space, i.e., the term representation for a given term gives the term a location in the high-dimensional space. For example, the numeric values can be floating point values or quantized representations of floating point values.

Generally, the associations are generated so that the relative locations of terms reflect semantic and syntactic similarities between the terms. That is, the relative locations of terms in the high-dimensional space reflect syntactic similarities between the terms, e.g., showing that, by virtue of their relative location in the space, words that are similar to the word “he” may include the words “they,” “me,” “you,” and so on, and semantic similarities, e.g., showing that, by virtue of their relative locations in the space the word “queen” is similar to the words “king” and “prince.” Furthermore, relative locations in the space may show that the word “king” is similar to the word “queen” in the same sense as the word “prince” is similar to the word “princess,” and, in addition, that the word “king” is similar to the word “prince” as the word “queen” is similar to the word “princess.”

Additionally, operations can be performed on the locations to identify terms that have a desired relationship to other terms. In particular, vector subtraction and vector addition operations performed on the locations can be used to determine relationships between terms. For example, in order to identify a term X that has a similar relationship to a term A as a term B has to a term C, the following operation may be performed on the vectors representing terms A, B, and C: vector(B)−vector(C)+vector(A). For example, the operation vector(“Man”)−vector(“Woman”)+vector(“Queen”) may result in a vector that is close to the vector representation of the word “King.”

Associations of terms to high dimensional vector representations having these characteristics can be generated by training a machine learning system configured to process each term in the vocabulary of terms to obtain a respective numeric representation of each term in the vocabulary in the high-dimensional space and to associate each term in the vocabulary with the respective numeric representation of the term in the high-dimensional space. Example techniques for training such a system and generating the associations are described in Tomas Mikolov, Kai Chen, Greg S. Corrado, and Jeffrey Dean, Efficient estimation of word representations in vector space, International Conference on Learning Representations (ICLR), Scottsdale, Ariz., USA, 2013.

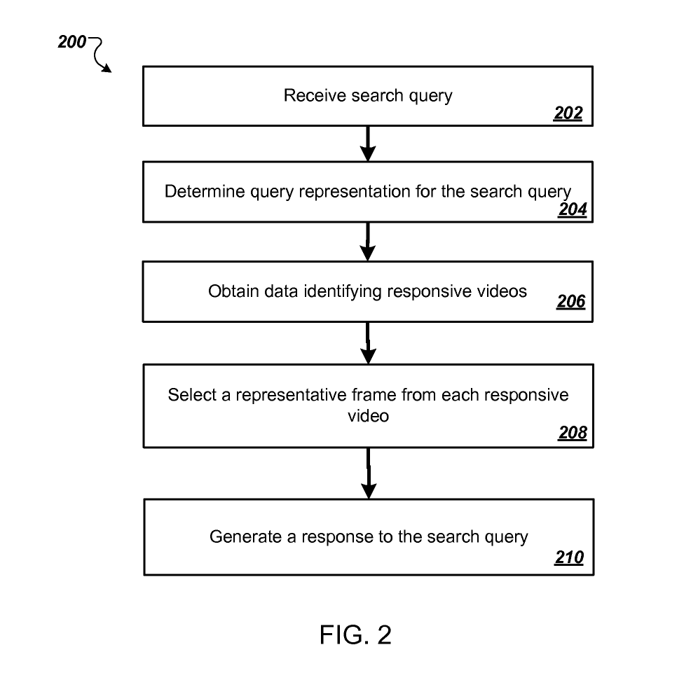

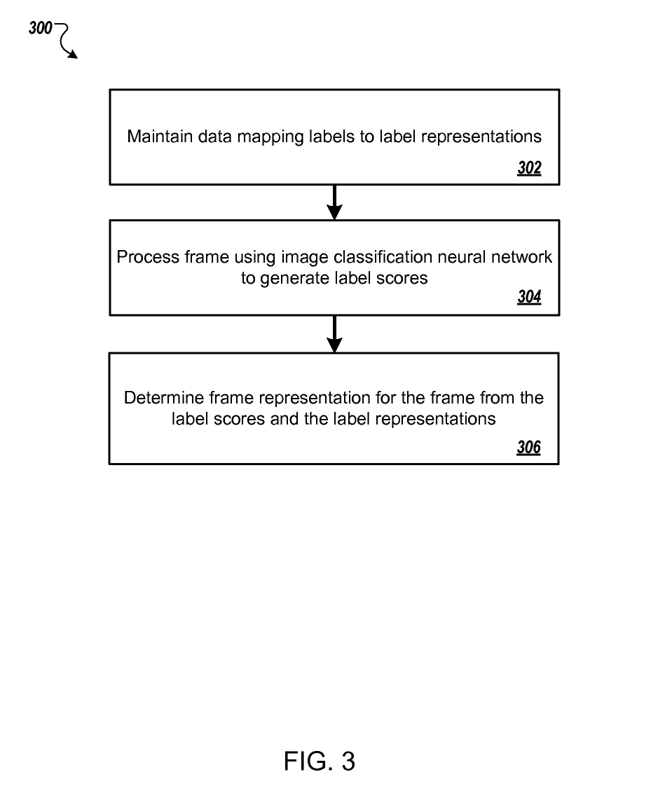

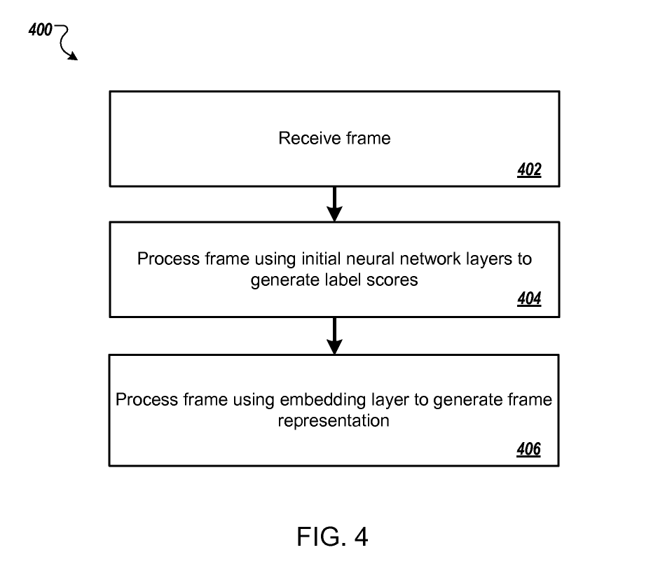

The frame representation repository 154 stores data that associates video frames from videos indexed in the index 122 with a frame representation for the frame. Like the term representations, the frame representations are vectors of numeric values in the high-dimensional space. Generating a frame representation for a video frame is described below with reference to FIGS. 3 and 4. Selecting a representative frame for a video in response to a received query using term representations and frame representations is described below with reference to FIG. 2.

FIG. 2 is a flow diagram of an example process 200 for generating a response to received search query. For convenience, the process 200 will be described as being performed by a system of one or more computers located in one or more locations. For example, a video search system, e.g., the video search system 100 of FIG. 1, appropriately programmed, can perform the process 200.

The system receives a search query (step 202). The search query includes one or more query terms.

The system generates a query representation for the search query (step 204). The query representation is a vector of numeric values in the high-dimensional space. In particular, to generate the query representation, the system determines a respective term representation for each query term in the received search query from data stored in a term representation repository, e.g., the term representation repository 152 of FIG. 1. As described above, the term representation repository stores, for each term in a vocabulary of terms, data that associates the term with a term representation for the term. The system then combines the term representations for the query terms to generate the query representation. For example, the query representation can be an average or other measure of central tendency of the term representations for the terms in the search query.

The system obtains data identifying responsive videos for the search query (step 206). The responsive videos are videos that have been classified by a video search engine, e.g., the video search engine 130 of FIG. 1, as being responsive to the search query, i.e., as matching or satisfying the search query.

The system selects a representative frame from each of the responsive videos (step 208). The system selects the representative frame from a given responsive video using frame representations for frames in the responsive video stored in a frame representation repository, e.g., the frame representation repository 154 of FIG. 1.

In particular, to select the representative frame from a responsive video, the system computes a respective distance measure between the query representation and each of the frame representations for the frames in the responsive video. For example, the distance measure can be a cosine similarity value, a Euclidian distance, a Hamming distance, and so on. Similarly, the system can also regularize the representations and then compute a distance measure between the regularized representations.

In some implementations, the system selects as the representative frame the frame from the responsive video that has a frame representation that is the closest to the query representation according to the distance measure.

Optionally, in these implementations, the system can verify whether the closest frame representation is sufficiently close to the query representation. That is, if a larger distance value represents closer representations according to the distance measure, the system determines that the closest frame representation is sufficiently close when the largest distance measure exceeds a threshold value. If a smaller distance value represents closer representations according to the distance measure, the system determines that the closest frame representation is sufficiently close when the smallest distance measure is below a threshold value.

If the closest frame representation is sufficiently close to the query representation, the system selects the frame having the closest frame representation as the representative frame. If the closest frame representation is not sufficiently close, the system selects a predetermined default frame as the representative frame. For example, the default frame may be a frame at a predetermined position in the responsive video, e.g., the first frame in the responsive video, or a frame that has been classified as the representative frame for the responsive video using a different technique.

In some other implementations, to determine whether the closest frame representation is sufficiently close to the query representation, the system maps the distance measures to probabilities using a score calibration model. The score calibration model may be, e.g., an isotonic regression model, a logistic regression model, or other score calibration model, that has been trained to receive the distribution of distance measures and, optionally, features of the frames that correspond to the distance measures, and to map each distance measure to a respective probability. The probability for a given frame represents the likelihood that the frame accurately represents the video relative to the received query. For example, the score calibration model may be trained on training data that includes distance measure distributions for video frames, and, for each distance measure distribution, a label that indicates whether or not a rater indicated that the frame having the closest distance measure accurately represented the video when selected in response to the rater's search query.

In these implementations, the system determines whether the highest probability, i.e., the probability for the frame having the closest frame representation, exceeds a threshold probability. When the highest probability exceeds the threshold probability, the system selects the frame having the highest probability as the representative frame. When the probability does not exceed the threshold value, the system selects the predetermined default frame as the representative frame.

The system generates a response to the search query (step 210). The response includes video search results that each identify a respective responsive video. In some implementations, each video search result includes a presentation of the representative frame from the video identified by the video search result. In some implementations, each video search result includes a link that, when selected by a user, initiates playback of the video starting from the representative frame. That is, the representative frame for a given video serves as an alternate starting point for the playback of the video.

FIG. 3 is a flow diagram of an example process 300 for generating a frame representation for a video frame. For convenience, the process 300 will be described as being performed by a system of one or more computers located in one or more locations. For example, a video search system, e.g., the video search system 100 of FIG. 1, appropriately programmed, can perform the process 300.

The system maintains data that maps each label in a predetermined set of labels to a respective label representation for the label (step 302). Each label is a term that represents a respective object category. For example the term “horses” may be the label for a horses category or the term “nine” may be the label for a category that includes images of the digit nine.

The label representation for a given label is vector of numeric values in the high-dimensional space. For example, the label representation for the label can be the term representation for the label stored in the term representation repository.

The system processes the frame using an image classification neural network to generate a set of label scores for the frame (step 304). The set of label scores for the frame includes a respective score for each of the labels in the set of labels and the score for a given label represents the likelihood that the frame includes an image of an object that belongs to the object category represented by the label. For example, if set of labels includes the label “horses” that represents the object category horses, the score for the “horses” label represents the likelihood that the frame contains an image of a horse.

In some implementations, the image classification neural network is a deep convolutional neural network that has been trained to classify input images by processing the input image to generate a set of label scores for the image. An example initial image classification neural network that is a deep convolutional neural network is described in Imagenet classification with deep convolutional neural networks, Alex Krizhevsky, Ilya Sutskever, and Geoffrey E. Hinton, NIPS, pages 1106-1114, 2012.

The system determines the frame representation for the frame from the label scores and the label representations for the labels (step 306). In particular, the system computes, for each of the labels, a weighted representation for the label by multiplying the label score for the label by the label representation for the label. The system then computes the frame representation for the frame by computing the sum of the weighted representations.

Once the system has determined the frame representation for a frame, the system can store the frame representation in the frame representation repository for use in selecting representative frames in response to received search queries.

In some implementations, the system generates the frame representations by processing the frame using a modified image classification neural network that includes an initial image classification neural network and an embedding layer. The initial image classification neural network can be the image classification neural network described above that classifies an input video frame by processing the input video frame to generate the label scores for the input video frame. The embedding layer is a neural network layer that is configured to receive the label scores for the input video frame and to process the label scores to generate the frame representation for the input video frame.

FIG. 4 is a flow diagram of an example process 400 for generating a frame representation for a video frame using a modified image classification neural network. For convenience, the process 400 will be described as being performed by a system of one or more computers located in one or more locations. For example, a video search system, e.g., the video search system 100 of FIG. 1, appropriately programmed, can perform the process 400.

The system processes the frame using an initial image classification neural network to generate a set of label scores for the frame (step 402).

The system processes the label scores for the frame using an embedding layer to generate a frame representation for the frame (step 404). In particular, in some implementations, the embedding layer is configured to receive the label scores for the frame, to compute, for each of the labels, a weighted representation for the label by multiplying the label score for the label by the label representation for the label, and to compute the frame representation for the frame by computing the sum of the weighted representations. In some other implementations, the embedding layer is configured to process the labels scores for the frame to generate the frame representation by transforming the label scores in accordance with current values of a set of parameters of the embedding layer.

The process 400 can be performed to predict a frame representation for a frame for which the desired frame representation is not known, i.e., a frame for which the frame representation that should be generated by the system is not known. The process 400 can also be performed to generate a frame representation for an input frame from a set of training data, i.e., a set of input frames for which the output that should be predicted by the system is known, in order to train the modified image classification neural network, i.e., to determine trained values for the parameters of the initial image classification neural network and, if the embedding layer has parameters, trained values for the parameters of the embedding layer, either from initial values of the parameters or from pre-trained values of the parameters.

For example, the process 400 can be performed repeatedly on input frames selected from a set of training data as part of a training technique that determines trained values for the parameters of the initial image classification neural network by minimizing a loss function using a conventional backpropagation training technique.

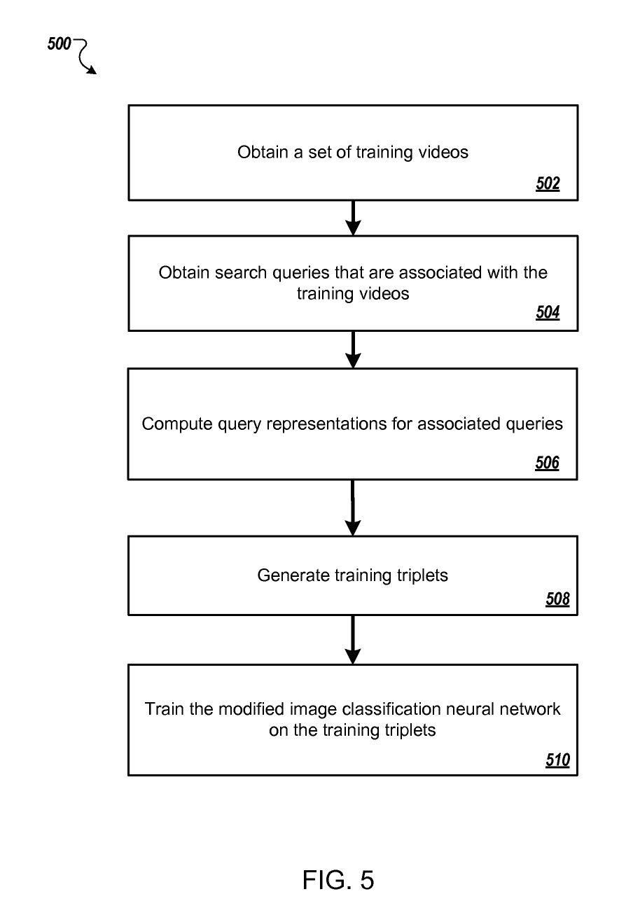

FIG. 5 is a flow diagram of an example process 500 for training a modified image classification neural network. For convenience, the process 500 will be described as being performed by a system of one or more computers located in one or more locations. For example, a video search system, e.g., the video search system 100 of FIG. 1, appropriately programmed, can perform the process 500.

The system obtains a set of training videos (step 502).

The system obtains, for each training video, search queries that are associated with the training video (step 504). The search queries associated with a given training video are search queries that users have submitted to a video search engine and that resulted in the users selecting a search result identifying the training video.

The system computes, for each training video, the query representations of the queries associated with the training video (step 506), e.g., as described above with reference to FIG. 2.

The system generates training triplets for training the modified image classification neural network (step 508). Each training triplet includes a video frame from a training video, a positive query representation, and a negative query representation. The positive query representation is a query representation for a query associated with the training video and the negative query representation is a query representation for a query that is not associated with the training video but that is associated with a different training video.

In some implementations, the system selects the positive query representation for the training triplet randomly from the representations for queries associated with the training video or generates respective training triplets for a given frame for each query that is associated with training video.

In some other implementations, for a given frame, the system selects as the positive query representation for the training triple that includes the frame the query representation that is the closest to the frame representation for the frame from among the representations for queries associated with the training video. That is, the system can generate the training triplets during the training of the network by processing the frame using the modified image classification neural network in accordance with current values of the parameters of the network to generate the frame representation and then selecting the positive query representation for the training triplet using the generated frame representation.

The system trains the modified image classification neural network on the training triplets (step 510). In particular, for each training triplet, the system processes the frame in the training triplet using the modified image classification neural network in accordance with current values of the parameters of the network to generate a frame representation for the frame. The system then computes a gradient of a loss function that depends on the positive distance, i.e., the distance between the frame representation and the positive query representation, and the negative distance, i.e., the distance between the frame representation and the negative query representation. The system can then backpropagate the computed gradient through the layers of the neural network to adjust the current values of the parameters of the neural network using conventional machine learning training techniques.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a search query, wherein the search query comprises one or more query terms;
determining a query representation for the search query, wherein the query representation is a vector of numbers in a high-dimensional space;
obtaining data identifying a plurality of responsive videos for the search query, wherein each responsive video comprises a plurality of frames, wherein each frame has a respective frame representation, and wherein each frame representation is a vector of numbers in the high-dimensional space;
selecting, for each responsive video, a representative frame from the responsive video using the query representation and the frame representations for the frames in the responsive video; and
generating a response to the search query, wherein the response to the search query includes a respective video search result for each of the responsive videos, and wherein the respective video search result for each of the responsive videos includes a presentation of the representative video frame from the responsive video.

2. The method of claim 1, wherein the respective video search result for each of the responsive videos includes a link to playback of the responsive video starting from the representative frame from the responsive video.

3. The method of claim 1, wherein selecting, for each responsive video, a representative frame from the responsive video using the query representation and the frame representations for the frames in the responsive video comprises:
computing a respective distance measure between the query representation and each of the frame representations for the frames in the responsive video frame.

4. The method of claim 3, wherein selecting, for each responsive video, a representative frame from the responsive video using the query representation and the frame representations for the frames in the responsive video further comprises:
selecting as the representative frame a frame having a frame representation that is closest to the query representation according to the distance measure.

5. The method of claim 3, wherein selecting, for each responsive video, a representative frame from the responsive video using the query representation and the frame representations for the frames in the responsive video further comprises:
generating a respective probability for each of the frames from the distance measures;
determining whether a highest probability for any of the frames exceeds a threshold value;
when the highest probability exceeds the threshold value, selecting the frame having the highest probability as the representative frame.

6. The method of claim 5, wherein selecting, for each responsive video, a representative frame from the responsive video using the query representation and the frame representations for the frames in the responsive video further comprises:
when the highest probability does not exceed the threshold value, selecting a default frame as the representative frame.

7. The method of claim 1, wherein determining the query representation for the search query comprises:
determining a respective term representation for each of the one or more terms in the search query, wherein the term representation is a representation of the term in the high-dimensional space; and
determining the query representation from the one or more term representations.

8. The method of claim 1, further comprising:
determining, for each of the responsive videos, the respective frame representation for each of the plurality of frames from the responsive video.

9. The method of claim 8, wherein determining the respective frame representation for each of the plurality of frames from the responsive video comprises:
maintaining data mapping each label in a predetermined set of labels to a respective label representation, wherein each label representation is a vector of numbers in the high-dimensional space;
processing the frame using a deep convolutional neural network to generate a set of label scores for the frame, wherein the set of label scores includes a respective score for each label in the predetermined set of labels, and wherein the respective score for each of the labels represents a likelihood that the frame contains an image of an object from an object category labeled by the label; and
computing the frame representation for the frame from the set of label scores for the frame and the label representations.

10. The method of claim 8, wherein computing the frame representation for the frame from the set of label scores for the frame and the label representations comprises:
computing, for each of the labels, a weighted representation for the label by multiplying the label score for the label by the label representation for the label; and
computing the frame representation for the frame by computing a sum of the weighted representations.

11. The method of claim 8, wherein determining the respective frame representation for each of the plurality of frames from the responsive video comprises:
processing the frame using a modified image classification neural network to generate the frame representation for the frame, wherein the modified image classification neural network comprises:
an initial image classification neural network configured to process the frame to generate a respective label score for each label of a predetermined set of labels, and
an embedding layer configured to receive the label scores and to generate the frame representation for the frame.

12. The method of claim 11, wherein the modified image classification convolutional neural network has been trained on a set of training triplets, each training triplet comprising a respective training frame from a respective training video, a positive query representation, and a negative query representation.

13. The method of claim 12, wherein the positive query representation is a query representation for a search query that is associated with the training video and the negative query representation is a query representation for a search query that is not associated with the training video.

14. A system comprising one or more computers and one or more storage devices storing instructions that when executed by the one or more computers cause the one or more computers to perform operations comprising:
receiving a search query, wherein the search query comprises one or more query terms;
determining a query representation for the search query, wherein the query representation is a vector of numbers in a high-dimensional space;
obtaining data identifying a plurality of responsive videos for the search query, wherein each responsive video comprises a plurality of frames, wherein each frame has a respective frame representation, and wherein each frame representation is a vector of numbers in the high-dimensional space;
selecting, for each responsive video, a representative frame from the responsive video using the query representation and the frame representations for the frames in the responsive video; and
generating a response to the search query, wherein the response to the search query includes a respective video search result for each of the responsive videos, and wherein the respective video search result for each of the responsive videos includes a presentation of the representative video frame from the responsive video.

15. The system of claim 14, wherein the respective video search result for each of the responsive videos includes a link to playback of the responsive video starting from the representative frame from the responsive video.

16. The system of claim 14, wherein selecting, for each responsive video, a representative frame from the responsive video using the query representation and the frame representations for the frames in the responsive video comprises:
computing a respective distance measure between the query representation and each of the frame representations for the frames in the responsive video frame.

17. The system of claim 16, wherein selecting, for each responsive video, a representative frame from the responsive video using the query representation and the frame representations for the frames in the responsive video further comprises:
selecting as the representative frame a frame having a frame representation that is closest to the query representation according to the distance measure.

18. The system of claim 16, wherein selecting, for each responsive video, a representative frame from the responsive video using the query representation and the frame representations for the frames in the responsive video further comprises:
generating a respective probability for each of the frames from the distance measures;
determining whether a highest probability for any of the frames exceeds a threshold value;
when the highest probability exceeds the threshold value, selecting the frame having the highest probability as the representative frame.

19. The system of claim 14, wherein determining the query representation for the search query comprises:
determining a respective term representation for each of the one or more terms in the search query, wherein the term representation is a representation of the term in the high-dimensional space; and
determining the query representation from the one or more term representations.

20. A computer program product encoded on one or more non-transitory computer readable media, the computer program product comprising instructions that when executed by one or more computers cause the one or more computers to perform operations comprising:
receiving a search query, wherein the search query comprises one or more query terms;
determining a query representation for the search query, wherein the query representation is a vector of numbers in a high-dimensional space;
obtaining data identifying a plurality of responsive videos for the search query, wherein each responsive video comprises a plurality of frames, wherein each frame has a respective frame representation, and wherein each frame representation is a vector of numbers in the high-dimensional space;
selecting, for each responsive video, a representative frame from the responsive video using the query representation and the frame representations for the frames in the responsive video; and
generating a response to the search query, wherein the response to the search query includes a respective video search result for each of the responsive videos, and wherein the respective video search result for each of the responsive videos includes a presentation of the representative video frame from the responsive video.
